(19) United States
(12) Patent Application Publication
(10) Pub. No.: US 2026/0014631 A1
(43) Pub. Date: Jan. 15, 2026

(54) TRADESMES APPARATUS AND METHOD TO ACCESS THE SPACE BEHIND A WALLBOARD

(71) Applicant: Ken MacLachlan, Victoria (CA)

(72) Inventor: Ken MacLachlan, Victoria (CA)

(21) Appl. No.: 18/769,381

(22) Filed: Jul. 10, 2024

(51) Int. Cl. B23D 61/00; B23D 51/10

(52) U.S. Cl. CPC B23D 61/006; B23D 51/10

(57) ABSTRACT

An elongated tool for use with an associated oscillating multitool having 1^{st} and 2^{nd} axial extremities. A mounting portion configured to center the tool for oscillation about a rotation axis is disposed proximate to the 1^{st} axial extremity thereof. A saw blade assembly comprising 1st and 2nd planar oscillating saw blades disposed in spaced mutually parallel relationship is disposed at the 2nd axial extremity of the elongated tool. Each of said 1st and 2nd cutters have a plurality of peripheral cutting teeth proximate to the 2nd axial extremity thereof and distal to the 1^{st} axial extremity.

### TECHNICAL FIELD

The present invention is generally directed to tools utilized in the construction industry. More particularly, the present invention is directed to oscillating multitools and tools cooperating with an oscillating multitool.

An oscillating multitool or oscillating saw is a power tool that oscillates unlike other power tools that rotate or reciprocate. The name “multitool” is a reference to the many functions that this tool can perform with a range of available attachments. Attachments are available for sawing, sanding, rasping, grinding, scraping, cutting, and polishing.

The prior art does not describe apparatus which will enable, for example, simultaneous cutting both sides of a slot in a wallboard.

### SUMMARY OF THE INVENTION

The shortcomings of the prior art are overcome and additional advantages are provided with an elongated tool for use with an associated oscillating multitool having 1^{st} and 2^{nd} axial extremities. A mounting portion configured to center the tool for oscillation about a rotation axis is disposed proximate to the 1^{st} axial extremity thereof.

In some embodiments, a saw blade assembly comprising 1st and 2nd planar oscillating saw blades in spaced mutually parallel relationship is disposed at the 2nd axial extremity of the elongated tool. Each of the 1st and 2nd oscillating saw blades have a plurality of peripheral cutting teeth proximate to the 2nd axial extremity thereof distal to the 1^{st} axial extremity.

In some embodiments the elongated tool further includes a planar support intermediate said 1st and 2nd planar oscillating saw blades to stabilize the respective positions of the 1^{st} and 2^{nd} planar oscillating saw blades.

The planar support may be disposed in perpendicular relationship to each of said 1st and 2nd planar oscillating saw blades. The 1st and 2nd oscillating saw blades may have a plurality of plunge cutting optimized teeth.

In some embodiments of the elongated tool has 1st and 2nd oscillating saw blades, each have a plurality of teeth and the tips of all the teeth at one axial extremity of the tool are coincident with a virtual curvilinear plane having a center of curvature coincident with the axis of movement of said other axial extremity.

Additional features and advantages are realized through the techniques of the present invention. Other embodiments and aspects of the invention are described in detail herein and are considered a part of the claimed invention.

### BRIEF DESCRIPTION OF DRAWINGS

Referring now to the drawing there is shown a multitool

The subject matter which is regarded as the invention is particularly pointed out and distinctly claimed in the concluding portion of the specification. Although specific features of various exemplary embodiments of the invention may be shown in some drawings and not in others, this is for convenience only. In accordance with the principles of the invention, any feature of a drawing maybe referenced and/or claimed in combination with any feature of any other drawing.

The invention, however, both as to organization and method of practice, together with the further objects and advantages thereof, may best be understood by reference to the following description taken in connection with the accompanying drawings in which:

FIG. 1 is an isometric view of an oscillating multitool which is attached a saw blade in accordance with one form of the present invention,

FIG. 2 is a partly schematic side view, of the saw blade illustrated in FIG. 1

FIG. 3 is a top view of the saw blade illustrated in FIG. 1,

FIG. 4 is a partly schematic isometric view illustrating the saw blade illustrated in FIG. 1.

### DETAILED DESCRIPTION OF THE INVENTION

The present invention utilizes the oscillating multi-tool for quickly and easily cutting a slot in, for example, wallboard. A need for cutting such a slot occurs in various scenarios. For example, an electrician may desire an open space to fish wires along the wall from one electrical outlet to another. Similarly, an electrician for other craftsmen may desire to have an opening in the wallboard adjacent to a stud to allow insertion of the head of a right-angle drill to drill a hole through the stud sized to accommodate whatever wires, cables, pipes or conduits must necessarily pass through the stud.

Another consideration in making such an opening is the difficulty of repairing any opening that is being made. It is fundamental that a repair of wallboard is typically made by cutting a rectangular opening around any damaged area and inserting a new piece of wallboard sized for insertion into the opening in the existing wallboard.

It is inherent in any sawing process that there is a kerf. The kerf is the width of the material that is removed during the cutting process. The term “swarf” is also used to describe the pieces of metal, wood, or plastic that are the debris or waste resulting from machining, woodworking, or similar subtractive (material-removing) manufacturing processes.

An oscillating blade does not clear swarf in the same way as a rotating blade. Accordingly, it is sometimes necessary to move the tool back and forth to allow accumulated swarf to clear from the cutting area.

It is desirable that both the cutting as well as the subsequent repair be easily accomplished. A particular advantage of the apparatus in accordance with the present invention is that the same apparatus can be used to make an opening in previous installed wallboard as well as to cut a repair plug from a new sheet of wallboard. The kerf will make possible using the identical tool to make both the original opening as well as to produce a repair plug.

Cutting blades for plunge cutting usually utilize straight blades with the teeth on the end, allowing the user to “plunge cut” directly into the material they are cutting.

The illustrated oscillating multitool 10 exemplifies a representative oscillating multitool. Different manufacturers provide a mechanical interface to tools. The present invention utilizes an elongated tool 12 having mounting, fastening or fitment portion 14 at a first axial extremity. The mounting portion conforms to common features suitable for engagement with substantially all of the multi-tools 10 and on the market. In some applications the mounting portion 14 is secured to the mounting interface of the multitool 10 by a cap nut (not shown) that have hexagonal recess (not shown) which can be tightened by a user to firmly hold the blade in place using a suitable Allen wrench or the like.

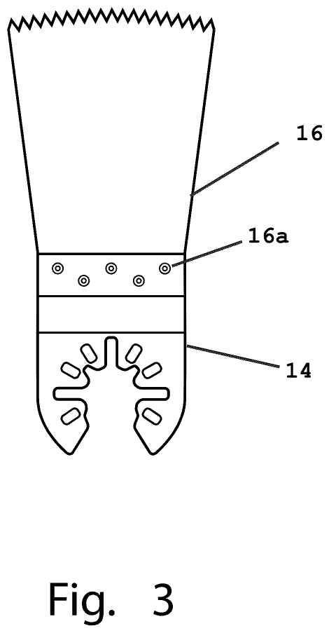

As shown in FIG. 3 the mounting portion 14 may overlap a portion of the main body 16. In such embodiments the mounting portion 14 in the main body 16 are secured by a plurality of spot welds 16a.

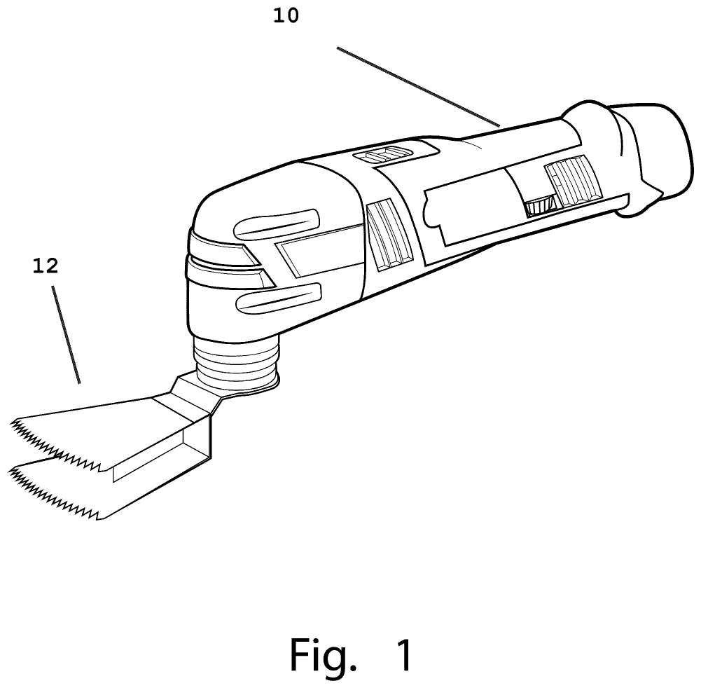

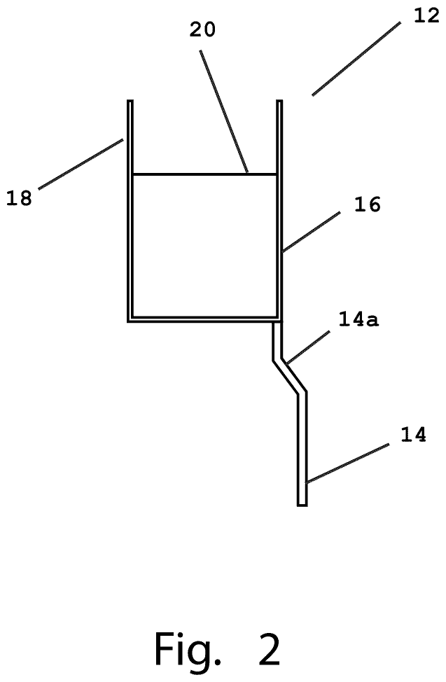

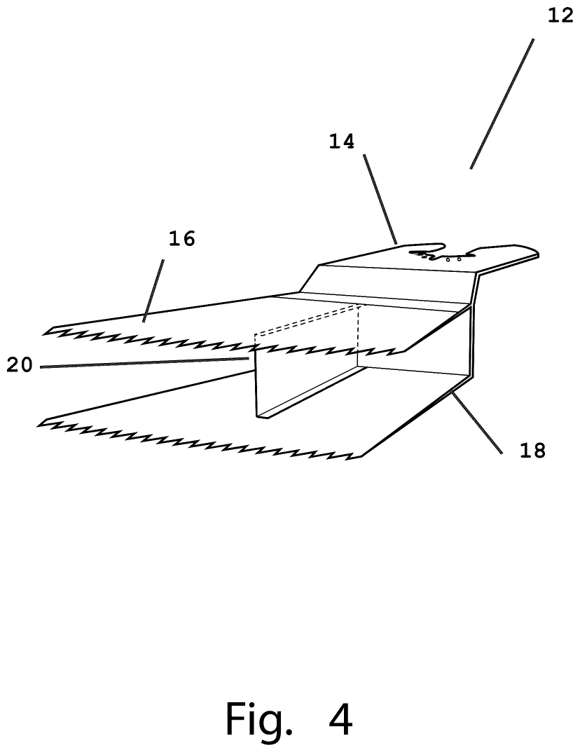

Because FIGS. 2 and 4 are partly schematic alternative design configurations are more apparent. More specifically the schematic approach better illustrates alternative application approaches. Although the FIGS. 1, 2 and 4 illustrate a mounting portion having an offset 14a, the offset is not necessary for all applications. More specifically, the offset 14a is employed primarily to facilitate flush cutting by spacing the body of the oscillating multitool 10 away from the worksite.

Thus, for example, in some embodiments both the mounting portion 14 as well as the first oscillating saw blade 16 are planar. Accordingly, they may be coplanar or even manufactured in one piece.

As shown in FIGS. 1-4, each oscillating saw blades 16, 18 is oriented to extend in the direction of the longitudinal axis of the multitool 10 housing.

A preferred embodiment of the present invention includes an elongated tool 12 in accordance with the present invention that includes 1^{st} and 2^{nd} oscillating saw blades 16, 18. Each of the oscillating saw blades 16, 18 is generally planar. The 1^{st} and 2^{nd} oscillating saw blades 16, 18 are disposed in parallel relationship. The spacing between the 1^{st} and 2^{nd} cutter elements 16, 18 is determined by the requirements of a particular application.

A support member 20 extends in perpendicular relationship to the 1^{st} and 2^{nd} oscillating saw blades 16, 18. More particularly, the support member 20 is planar and disposed in perpendicular relationship to those the 1^{st} and 2^{nd} oscillating saw blades 16, 18.

The illustrated embodiment as best seen in FIG. 3 includes an elongated tool having cutting edges of the oscillating saw blades 16, 18 at one axial extremity and a mounting surface 14 at the other axial extremity. The illustration shows a preferred embodiment, however, those skilled in the art will recognize that alternative blade constructions may also be used for some applications. For many applications blades particularly adapted for plunge cutting will work best.

In some embodiments the tips of all the teeth at one axial extremity of the tool are coincident with a virtual curvilinear plane having a center of curvature coincident the axis of movement of said other axial extremity.

In some embodiments the blades may be composed of a bimetallic strip comprising a steel strip and a narrower high speed steel strip. In some cases, the narrower high speed steel strip can be made of a material that includes at least one part metal or that is composed of at least one hard metal. The hard metal in this case preferably includes as a reinforcement phase, at least one carbide for example tantalum carbide, titanium carbide and/or tungsten carbide and/or a nitride for example boron nitride and/or titanium nitride.

In some embodiments each of the cutters are made from a hardenable steel sheet in one piece. A stamping operation produces a blank having a mounting extremity. Thereafter a plurality of such respective blanks are stacked and subsequently annealed for an elongated tool as described in claim 1 wherein each of said 1st and 2nd cutters have a plurality of plunge cutting optimized teeth. The overall shape mounting extremity may be produced by a stamping operation. Thereafter, a plurality of such blanks are clamped in a fixture and then annealed for recrystallization and austenization and quenched thereafter, to harden the blanks. Thereafter, saw teeth are provided along the periphery of the cutting blades.

In some embodiments the 1st and 2nd cutters have a plurality of plunge cutting optimized teeth.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

It will be understood that, in general, terms used herein, and especially in the appended claims, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood that if a specific number of an introduced claim recitation is intended such an intent will be explicitly recited in the claim, and in the absence of such recitation no such intent is present. For example, as an aid to understanding, the following appended claims may contain usage of introductory phrases such as “at least one” or “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “an imager” should typically be interpreted to mean “at least one imager”); the same holds true for the use of definite articles used to introduce claim recitations. In addition, even if a specific number of an introduced claim recitation is explicitly recited, it will be recognized that such recitation should typically be interpreted to mean at least the recited number (e.g., the bare recitation of “two images,” or “a plurality of images,” without other modifiers, typically means at least two images). Furthermore, in those instances where a phrase such as “at least one of A, B, and C,” “at least one of A, B, or C,” or “an [item] selected from the group consisting of A, B, and C,” is used, in general such a construction is intended to be disjunctive (e.g., any of these phrases would include but not be limited to systems that have A alone, B alone, C alone, A and B together, A and C together, B and C together, or A, B, and C together, and may further include more than one of A, B, or C, such as A₁, A₂, and C together, A, F₁, B₂, C₁, and C₂ together, or B₁ and B₂ together). It will be further understood that virtually any disjunctive word or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims.

Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

1. A tool for use with an associated oscillating multitool which comprises:
an elongated oscillating saw blade tool having 1^{st} and 2^{nd} axial extremities;
a mounting portion configured to center the tool for oscillation about a rotation axis proximate to the 1^{st} axial extremity thereof;
a saw blade assembly comprising 1st and 2nd planar oscillating saw blades disposed in spaced mutually parallel relationship, each of said 1st and 2nd oscillating saw blades having a plurality of peripheral cutting teeth proximate to the 2nd axial extremity thereof distal to said 1^{st} axial extremity.

2. An elongated tool as described in claim 1 further including a planar support intermediate said 1st and 2nd planar oscillating saw blades to stabilize the respective positions of said 1^{st} and 2^{nd} planar cutters.

3. An elongated tool as described in claim 1 wherein said planar support is disposed in perpendicular relationship to each of said 1st and 2nd planar oscillating saw blades.

4. An elongated tool as described in claim 1 wherein each of said 1st and 2nd oscillating saw blades have a plurality of plunge cutting optimized teeth.

5. An elongated tool as described in claim 1 wherein each of said 1st and 2nd oscillating saw blades have a plurality of teeth and the tips of all the teeth at one axial extremity of the tool are coincident with a virtual curvilinear plane having a center of curvature coincident with the axis of movement of said other axial extremity.

6. A method for cutting a slot in a planar surface which comprises:
providing an oscillating multitool;
providing an elongated oscillating saw blade tool having 1^{st} and 2^{nd} axial extremities;
providing a mounting portion configured to center the tool for oscillation about a rotation axis proximate to the 1^{st} axial extremity thereof;
providing a saw blade assembly comprising 1st and 2nd planar oscillating saw blades disposed in spaced mutually parallel relationship, each of said 1st and 2nd oscillating saw blades having a plurality of peripheral cutting teeth proximate to the 2nd axial extremity thereof distal to said 1^{st} axial extremity and
cutting a slot in the planar surface by advancing the saw blade assembly along a face of the planar surface to simultaneously cut both sides of the slot.
